(19) United States
(12) Patent Application Publication
(10) Pub. No.: US 2006/0079296 A1
(43) Pub. Date: Apr. 13, 2006

(54) Voltage supply device and method for operating such a voltage supply device

(75) Inventor: Dietmar Scheiblhofer, Kaindorf (AT)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/240,817

(22) Filed: Sep. 30, 2005

(30) Foreign Application Priority Data
Sep. 30, 2004 (DE) 10 2004 047 765.5

(51) Int. Cl. H04B 1/38

(52) U.S. Cl. 455/572; 455/571

(57) ABSTRACT

A voltage supply device for use in portable devices comprises a connection which is designed to connect an energy storage device, and a first means which is designed to provide a first supply voltage when the energy stored in the energy storage device is above a threshold value and not to provide a supply voltage when the stored energy is below the threshold value. The voltage supply device has a second means which is designed to provide a second supply voltage for operating a contactless interface irrespective of the threshold value.

### CROSS-REFERENCE TO RELATED APPLICATION

This application claims priority to German Patent Application Serial No. 102004047765.5, which was filed on Sep. 30, 2004 and is incorporated herein by reference in its entirety.

### FIELD OF THE INVENTION

The invention relates to a voltage supply device for use in portable devices, having a connection which is designed to connect an energy storage device, and a first means which is designed to provide a first supply voltage when the energy stored in the energy storage device is above a threshold value and not to provide a first supply voltage when the stored energy is below the threshold value. The invention also relates to a method for operating such a voltage supply device.

### BACKGROUND OF THE INVENTION

The use of mobile telephones, so-called cell phones, is nowadays no longer restricted only to the actual transmission of messages by means of conventional telephony or short text messages. The latter is also known as a Short Message Service, SMS for short.

It is only possible to transmit messages via a mobile radio network using a so-called SIM card. The acronym stands for “Subscriber Identification Module”. The SIM card contains an individual identifier which can be unambiguously identified in all mobile radio networks. It is therefore possible to bill call charges irrespective of the mobile telephone in which the card is used. Telephone numbers and text messages, for example, can also be stored in the memory area of the card. In addition to this, a program which can be used for remote maintenance or reprogramming of the mobile telephone initiated by the network operator is often installed in more modern SIM cards.

It is already possible to use mobile telephones to execute and bill for purchasing operations. For example, there are automatic vending machines which are similar to conventional coin-operated automatic vending machines in terms of what they offer and the way they are configured. In order to make the purchase, the buyer calls a telephone number given on the automatic machine. Once the call has been made and a selection key has optionally been pressed, the automatic vending machine releases the desired article and a corresponding charge is made to the mobile telephone account. Similar methods are used for selling or reserving tickets by predefined text being transmitted by means of a text message. This and similar methods are associated with making a call or sending a text message via a mobile radio network.

In terms of future possible uses, it may be predicted that mobile telephones will be equipped with a contactless interface. This makes it possible for the mobile telephone to interchange data with a device which is directly adjacent to it without using the mobile radio network, in a similar manner to communication which is known between smartcards and corresponding reading devices.

Communication via the contactless interface without using telephony or sending a text message is suitable for purchasing operations from automatic machines, in particular automatic ticket machines. If both the automatic vending machine and the mobile telephone are equipped with a contactless interface, the purchasing operation requires only the transmission of individual characteristic data, which is stored on the SIM card for example, to allow billing by making a corresponding charge to the mobile telephone account.

In order to communicate via the contactless interface for a purchasing operation, the mobile telephone is moved into the vicinity of the interface of the automatic vending machine. The relevant data can be transmitted in a simple manner by pressing a key. This method allows a ticket to be issued as a user passes the machine, for example. This is much easier and quicker than the purchasing operation with conventional automatic ticket machines since the time-consuming payment operation using cash or a credit or debit card, which is inserted into a reading apparatus, is dispensed with. The method is also less complicated than the above-described purchasing operations using mobile telephones, for which purchasing operations the mobile telephones communicate via the mobile radio network.

One disadvantage of the method described above is that the mobile telephone has to be ready to operate in order to carry out the purchasing operation, so that the individual characteristic data needed for billing can be transmitted. In order to ensure that a mobile telephone which comprises various functional blocks is ready to operate, its voltage supply device is designed in such a way that the various supply voltages provided for the functional blocks are switched off as soon as the charge state of a storage battery in the mobile telephone falls below a threshold value. The mobile telephone is no longer ready to operate.

### SUMMARY OF THE INVENTION

A voltage supply device for use in portable devices, having a connection which is designed to connect an energy storage device, a first means which is designed to provide a first supply voltage when the energy stored in the energy storage device is above a threshold value and not to provide a supply voltage when the stored energy is below the threshold value, and a second means which is designed to provide a second supply voltage for operating a contactless interface irrespective of the threshold value.

A method for operating a voltage supply device including the steps of providing an energy storage device, providing a contactless interface, determining a charge state of the energy storage device and comparing the charge state with a predetermined threshold value, providing a first supply voltage and providing a second supply voltage which is provided for operating the contactless interface when the charge state in the energy storage device is above a threshold value, and providing only the second supply voltage when the charge state is below the threshold value.

### BRIEF DESCRIPTION OF THE DRAWINGS

The invention is explained below using exemplary embodiments and with reference to the drawing, in which:

FIG. 1 shows a voltage supply device which is connected to an energy storage device, a contactless interface and a functional block;

FIG. 2 shows a voltage supply device which is connected to an energy storage device, a contactless interface, a device for operating a SIM card, and further functional blocks; and

FIG. 3 shows a voltage supply device which is connected to an energy storage device, a device for operating a SIM card, this device being connected in parallel, and further functional blocks.

### DETAILED DESCRIPTION OF PREFERRED EMBODIMENTS OF THE INVENTION

An object of the present invention is to specify an arrangement in which a function which is not dependent on the telephone functioning is reliably provided.

The object is achieved by a voltage supply device of the type mentioned in the introduction, wherein, according to the invention, a second means is provided and is designed to provide a second supply voltage for operating a contactless interface irrespective of the threshold value.

This arrangement makes use of the fact that the process of telephony or the transmission of text messages via a mobile radio network is far more complicated than relatively simple communication via two directly adjacent contactless interfaces.

When the charge state of the storage battery falls below a defined threshold value, the mobile telephone is deactivated since none of the operating voltages is provided any longer. This is the case even though approximately five percent of the storable energy may be available in the storage battery as residual energy.

Since communication via the contactless interface, in particular when it involves a simple purchasing operation in which only the individual characteristic data has to be transmitted, is relatively uncomplicated and does not require a great amount of energy, this operation can also be carried out when telephony is no longer possible on account of the energy charge state of the storage battery. The necessary residual charge of the storage battery is sufficient for this purpose.

The voltage supply device according to the invention is therefore designed in such a way that, when the charge state falls below the threshold value, all of the voltages for operating the mobile telephone are no longer switched off, but operating voltages which are required for operating the contactless interface continue to be provided.

This voltage supply device advantageously makes it possible not only to operate the contactless interface but also to access the SIM card. Access may also be restricted since it is sufficient for most applications which make use of the contactless interface, in particular purchasing operations, if only the individual characteristic data which is stored on the SIM card is available.

It is therefore also possible to automatically execute purchasing transactions via the contactless interface using a voltage supply device according to the invention when the telephony devices of the mobile telephone are already deactivated on account of the low charge state of the storage battery.

The voltage supply device of a mobile telephone is generally in the form of an integrated circuit module which is connected to the power supply device and provides various supply voltages at its output end. In mobile telephones, the number of various supply voltages which are intended for various functional blocks of a mobile telephone is in the range of from ten to twelve, for example. There is therefore generally a potential difference between the various supply voltages.

When enhancing the circuit module with the feature according to the invention, it is possible to further develop mobile telephones in a simple manner by integrating a contactless interface on the already existing structure.

The method for operating a voltage supply device according to the invention comprises: providing an energy storage device; providing a contactless interface; determining the charge state of the energy storage device and comparing the charge state with a predetermined threshold value; providing a first supply voltage and providing a second supply voltage which is provided for operating the contactless interface when the charge state in the energy storage device is above a threshold value, and providing only the second supply voltage when the charge state is below the threshold value.

In order to check the charge state of the energy storage device, it is not necessary to precisely determine its charge state. It is sufficient to use suitable criteria, for example the provided voltage, to establish whether the charge state is below the threshold value.

The voltage supply device can be designed in such a way that, once the charge state falls below the threshold value, the voltage for the interface is either switched off when the charge state falls below a further lower threshold value, or is automatically switched off when the storage battery is completely empty.

Access to the individual characteristic data of the SIM card is advantageously also ensured by devices whose supply voltage is provided irrespective of the threshold value, in order to execute automatic purchasing operations.

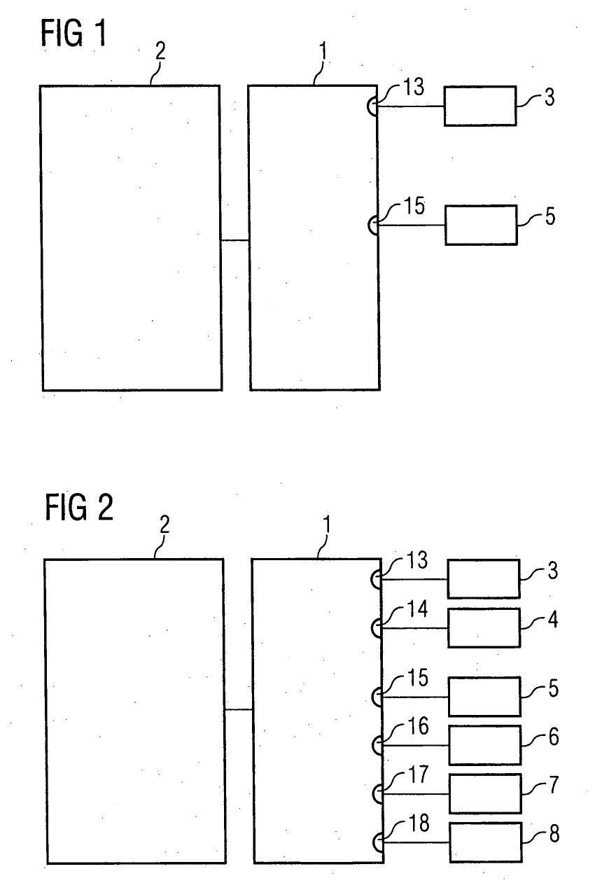

FIG. 1 shows a simple exemplary embodiment of the subject of the invention. The voltage supply device 1 is connected to an energy storage device 2. The voltage supply device 1 has a first means 15 for providing a supply voltage. A functional block 5 is connected to this supply voltage by way of example. The voltage supply device 1 also has a second means 13 which is designed to provide a second supply voltage for the contactless interface 3 which is connected to the second means 13.

The energy storage device is generally a rechargeable storage battery, but it is also feasible for it to be designed as a non-rechargeable energy source, for example in the form of a battery. The energy stored in the energy storage device 2 is determined in the voltage supply device 1 by comparing the energy with a specified threshold value. It is not necessary to determine the exact charge state, but merely whether it has fallen below the threshold value. The cell voltage is compared with a threshold value, for example.

If the energy stored in the energy storage device 2 falls below the threshold value, a first supply voltage is no longer provided by the first means 15 for operating the connected functional block 5. The supply voltage for operating the contactless interface 3 is still provided by the second means 13 in this case.

The voltage supply device 1 is designed in such a way that the second supply voltage, which is provided by the second device 13, is switched off as soon as either the energy stored in the energy storage device 2 falls below a second threshold value or the energy storage device 2 is completely empty.

FIG. 2 shows an exemplary embodiment which differs from that shown in FIG. 1 in that further first means 16, 17 and 18 for providing further first supply voltages are provided. The first supply voltages supply power to the connected functional blocks 5, 6, 7 and 8. The first supply voltages generally exhibit a potential difference. In the case of a mobile telephone, examples of these functional blocks include a display device, a keypad, a loudspeaker, a microphone, an antenna or a circuit element.

A second means 13 and a third means 14 are also provided. The second means 13 provides the supply voltage for the contactless interface 3. The third means 14 provides the supply voltage for a device 4 for operating a SIM card.

When the energy stored in the energy storage device 2 falls below the threshold value, no supply voltage is available at the first means 15, 16, 17 and 18 any longer, with the result that operation of the functional blocks 5, 6, 7 and 8 connected to the supply voltage is no longer possible. In contrast, operation of the contactless interface 3 and the device 4 for operating the SIM card is still possible.

It should be noted that the functionality of the SIM card may also be available in restricted fashion. In most cases, it is sufficient if only the individual characteristic data of the SIM card is available. If telephony is no longer possible, it is generally not necessary for it to be possible, for example, to change the telephone numbers stored on the SIM card or even only for them to be available. In these cases, the device 4 for operating the SIM card comprises a first and a second functional block. The first functional block is supplied with power by one of the first means, so that it is deactivated as soon as the charge state of the storage battery falls below the threshold value. The second functional block continues to be supplied with power by the third means 14 when the charge state falls below the threshold value. The second functional block enables the characteristic data of the SIM card to be provided and transmitted, this characteristic data being necessary for executing, by way of example, automatic purchasing operations via the contactless interface.

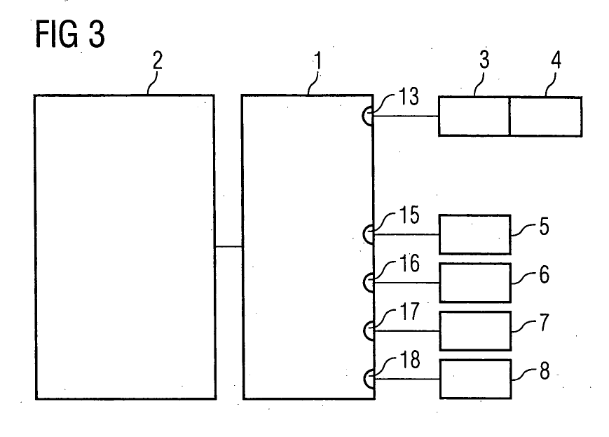

FIG. 3 shows an alternative exemplary embodiment which differs from that illustrated in FIG. 2 in that the second means 13 provides the supply voltage for two functional blocks which are coupled to each other and are the contactless interface 3 and the device 4 for operating the SIM card.

In this case too, a supply voltage is no longer available at the first means 15, 16, 17 and 18 after the stored energy falls below a threshold value in the energy storage device 2. In contrast, operation of the contactless interface 3 and the device 4 for operating the SIM card, which are fed via the second device 13, is still possible.

The device 4 for operating the SIM card can of course be designed in such a way that only restricted operation of the SIM card is possible as soon as the charge state has fallen below the threshold value. The corresponding designs, which relate to the exemplary embodiment according to FIG. 2, also apply in this regard.

It should be noted that the second means 13 and the third means 14 for providing a supply voltage do not only have to be restricted to being coupled to the contactless interface and the device for operating the SIM card when a charge state of the energy storage device is below the threshold value. Further means could equally be provided which provide a supply voltage irrespective of the charge state. It is also feasible to connect further or alternative functional blocks whose functionality is to be ensured irrespective of telephony.

Reference is made to the fact that the exemplary embodiments illustrated in FIGS. 1, 2 and 3 can also be combined with one another.

Although the subject of the invention is preferably used in mobile telephones, it is not restricted to this. Instead, use in all mobile communication devices, for example so-called pagers, is also feasible.

Similarly, communication via the contactless interface is not only restricted to purchasing operations but, by way of example, also allows access to be restricted and monitored via the contactless interface. Use of the contactless interface for the direct interchange of data between mobile telephones in the immediate vicinity of one another without using the mobile radio network is equally possible.

What is claimed is:

1. A voltage supply device for use in portable devices, comprising:
a connection which is designed to connect an energy storage device;
a first means which is designed to provide a first supply voltage when the energy stored in the energy storage device is above a threshold value and not to provide a supply voltage when the stored energy is below the threshold value; and
a second means which is designed to provide a second supply voltage for operating a contactless interface irrespective of the threshold value.

2. The voltage supply device as claimed in claim 1, wherein the energy storage device can be recharged.

3. The voltage supply device as claimed in claim 1, wherein further first means are provided and designed to provide further first supply voltages when the energy stored in the energy storage device is above the threshold value and not to provide any further supply voltages when the stored energy is below the threshold value.

4. The voltage supply device as claimed in claim 1, wherein a third means is provided and designed to provide a third supply voltage for operating a SIM card irrespective of the threshold value.

5. A communication device having a voltage supply device as claimed in claim 1.

6. The communication device as claimed in claim 5, wherein the second means is designed to provide the second supply voltage for operating a contactless interface and a SIM card.

7. The communication device as claimed in claim 5, further comprising:
a first functional unit which is supplied with the first supply voltage; and
a second functional unit which is supplied with the second supply voltage, with the second functional unit comprising means for acquiring and transmitting characteristic data of a SIM card.

8. The communication device as claimed in claim 5, wherein the communication device is a mobile telephone.

9. The communication device as claimed in claim 5, wherein further functional units, which are designed for telephony, are supplied with first supply voltages.

10. The communication device as claimed in claim 7, wherein the contactless interface is designed to transmit the characteristic data of the SIM card.

11. The communication device as claimed in claim 5, wherein the contactless interface is designed to transmit or receive data for executing an automatic purchasing operation.

12. The communication device as claimed in claim 11, wherein the purchasing operation involves issuing a ticket.

13. A method for operating a voltage supply device, comprising the steps of:
providing an energy storage device;
providing a contactless interface;
determining a charge state of the energy storage device and comparing the charge state with a predetermined threshold value;
providing a first supply voltage and providing a second supply voltage which is provided for operating the contactless interface when the charge state in the energy storage device is above a threshold value; and
providing only the second supply voltage when the charge state is below the threshold value.

14. The method as claimed in claim 13, further comprising the steps of:
providing a SIM card; and
providing a third supply voltage for operating the SIM card when the charge state is above or below the threshold value.

15. The method as claimed in claim 13, further comprising the steps of:
providing a SIM card; and
supplying power to the SIM card by the second supply voltage.

16. The method as claimed in claim 14, wherein a first functional unit is supplied with the first supply voltage, and a second functional unit is supplied with the second or third supply voltage, with the second functional unit comprising means for acquiring and transmitting characteristic data of the SIM card.

17. The method as claimed in claim 13, further comprising the steps of:
providing an automatic vending device; and
transmitting data between the contactless interface (3) and the automatic vending device in order to automatically execute a purchasing operation, irrespective of the charge state of the energy storage device.

18. The method as claimed in claim 17, wherein a ticket is issued during the purchasing operation.

19. A voltage supply device for use in portable devices, comprising:
a connection which is designed to connect an energy storage device;
a first means for providing a first supply voltage when the energy stored in the energy storage device is above a threshold value and for not providing a supply voltage when the stored energy is below the threshold value; and
a second means for providing a second supply voltage for operating a contactless interface irrespective of the threshold value.
